(19) United States
(12) Patent Application Publication
(10) Pub. No.: US 2013/0010801 A1
(43) Pub. Date: Jan. 10, 2013

(54) SYSTEM AND METHOD FOR CONGREGATING DISPARATE BROADBAND INFRASTRUCTURE

(76) Inventors: Larry J. Morrow, Kennesaw, GA (US); Claye K. Hart, (US)

(21) Appl. No.: 13/366,112

(22) Filed: Feb. 3, 2012

Related U.S. Application Data
(60) Provisional application No. 61/439,022, filed on Feb. 3, 2011.

(51) Int. Cl. H04L 12/66

(52) U.S. Cl. 370/401

(57) ABSTRACT

The present invention is a system and method of configured to congregate the services and content provided by a plurality of providers onto a single broadband network controlled by a CONVERGED BROADBAND INFRASTRUCTURE™ software module. The CONVERGED BROADBAND INFRASTRUCTURE™ software module enables the connecting of a plurality of provider legacy systems to the single broadband network and the distribution of the services of the plurality of provider legacy systems to a plurality of end users over the single broadband network. The plurality of provider legacy systems include a plurality of provider legacy systems of the type offering at least one of the same type of services comprising voice, data and internet. The CONVERGED BROADBAND INFRASTRUCTURE™ software module allows for the distribution of multiple services offered by different services providers over single broadband network.

### CROSS REFERENCE TO RELATED APPLICATIONS

This patent application is a nonprovisional of U.S. Provisional Patent Application No. 61/439,022, filed Feb. 3, 2011, entitled SYSTEM AND METHOD FOR CONGREGATING DISPARATE BROADBAND INFRASTRUCTURE, the disclosure of which is incorporated herein by reference in its entirety.

### BACKGROUND OF THE INVENTION

I. Field of the Invention

The present invention relates to improved methods and systems for delivery of telecommunications services including phone, video and internet through the extension of the maximum distance that each optical signal regeneration point or node in a broadband network may deliver passive optical signals. The systems and methods further provide a telecommunications infrastructure that allows for the transport of native signals of multiple telecommunications service providers over the same broadband network.

II. Background Information

Current broadband infrastructure network software is provided in a fashion that facilitates the support of only one provider of services on the network infrastructure. There is a need for an all fiber-optic network infrastructure that delivers services via a 10 Gbps Backbone where services are delivered via a 1 Gbps Ethernet Passive Optical Network (“ePON”) Architecture. As a result, at each optical signal regeneration point or node, services can be extended from each ePON at a density of 1×32 whereas the max distance each Passive Optical Network (“PON”) can deliver passive optical services without powered device amplification is 3 Miles. Between nodes, the infrastructure can deliver passive optical signals at a maximum range of 43 miles. As a result, the network will be able to deliver live optical connections to every city and county within an urban or rural region to allow all service to be delivered cost effectively. Existing communications platforms are configured to allow only one provider to distribute services on the infrastructure. There is a need for a broadband infrastructure that supports the transportation of native service signals from a plurality of phone service providers, a plurality of internet service providers, and a plurality of video service providers. Such a system would need to be configured such that the video includes at least two RF with return cable providers, at least two Satellite Providers utilizing a single satellite headend, and at least one IPTV Provider.

There is a need for broadband network infrastructure that that connects every identified anchor institution directly to the fiber-optic network. In such an environment, each connected anchor institution will have instant access to voice, video and data services over a single connection. There is also a need for broadband infrastructure configured to allow each end-user to choose amongst the available service providers who have interconnected to the fiber-optic network and are delivering their services over the broadband infrastructure. In the past, infrastructure companies exclusively built and leased dark fiber facilities to service providers or provided tiered internet access bandwidth or back-haul point-to-point capacity. There is a need for broadband network infrastructure that aggregates the subscribed service provider services and delivers the services to their target customer at the port level.

### SUMMARY OF THE INVENTION

Consistent with embodiments of the present invention, the present invention comprises a method and system configured to aggregate the services and content provided by a plurality of providers onto a single broadband network controlled by a CONVERGED BROADBAND INFRASTRUCTURE™ software module. The CONVERGED BROADBAND INFRASTRUCTURE™ software module enables the connecting of a plurality of provider legacy systems to the single broadband network and the distribution of the services of the plurality of provider legacy systems to a plurality of end users over the single broadband network. The plurality of provider legacy systems include a plurality of provider legacy systems of the type offering at least one of the same type of services comprising voice, data and internet. The CONVERGED BROADBAND INFRASTRUCTURE™ software module allows for the distribution of multiple services offered by different services providers over single broadband network.

It is to be understood that both the foregoing summary of the invention and the following detailed description are exemplary and explanatory only, and should not be considered restrictive of the scope of the invention, as described and claimed. Further, features and/or variations may be provided in addition to those set forth herein

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is an equipment and network architecture of an embodiment of the present invention;

FIG. 2 is a block diagram illustrating service delivery process flow from the service provider to the end user in an embodiment of the present invention; and

FIG. 3 is a process flow diagram of the module interface, of the present invention.

### GENERAL DESCRIPTION

Consistent with embodiments, the present invention is an improved method and system for delivery of telecommunications services including phone, video and internet through the extension of the maximum distance that each optical signal regeneration point or node in a network may deliver passive optical signals. The system and method further provides a telecommunications infrastructure that allows for the transport of native signals of multiple telecommunications service providers over the same network which, traditionally only one service provider was allowed to transmit services.

The method and system of the present invention includes a CONVERGED BROADBAND INFRASTRUCTURE™ software module that allows a defined number of service providers to occupy the same broadband network infrastructure with security compartmentalization, without data contention and clear delineation of traffic to specific end device ports. The CONVERGED BROADBAND INFRASTRUCTURE™ software module allows connection counts over the broadband network infrastructure so that accurate billing can be provided to each service provider connected at a TeleTOLL™ system. A TeleTOLL™ system is a system that allows the systems of service and content providers to connect to and interface with the broadband network infrastructure of the present invention. The CONVERGED BROADBAND INFRASTRUCTURE™ software module is essential to broadband network infrastructure systems described herein that connect existing legacy voice, video, data and wireless systems of Service Providers. It is also critical to content providers such as Federal and State Governments, Police and Fire communication departments, Utility O&M, Local Governments, Educational organizations and specific sub-departments such as the Department of Labor that will use a broadband infrastructure network in a broadcast, point to point communications or virtual community networks configuration.

The CONVERGED BROADBAND INFRASTRUCTURE software module within the present invention is utilized to implement Wavelength Division Multiplexing into a routing table to accurately track packets from specific service providers to their proper location. The CONVERGED BROADBAND INFRASTRUCTURE™ software module is configured to accurately count packets and data rates from specific service providers to their proper location. The CONVERGED BROADBAND INFRASTRUCTURE™ software module is also designed to encompass wavelength modulation and tracking for high traffic networks. This allows for a data stream to be changed on the fly from one wavelength to another without losing security. The CONVERGED BROADBAND INFRASTRUCTURE™ software module is also configured to implement virtual local area networks (V-LAN) into a service provider and end user demark connection table to track virtual connections from a specific service provider to their specific end user demark equipment port. The CONVERGED BROADBAND INFRASTRUCTURE™ software module is also configured to implement embedded VLANS into high level routing tables, specifically Border Gateway Protocol version 4 (BGPv4), Multi-protocol label switching (MPLS), Open Shortest Path First (OSPF). It is also configured to implement embedded VLANS onto a GPON and EPON equipped last mile architecture system. The CONVERGED BROADBAND INFRASTRUCTURE™ software module is also configured to implement Radio Frequency (RF) blocking technology at the end user demarcation equipment to enable RF multi-service provider based video systems. The CONVERGED BROADBAND INFRASTRUCTURE™ software module is also configured to implement the convergence of wide area wireless technology, such as 4G, directly with terrestrial fiber optic networks. It is also configured to implement virtual routing paths in a wide area network or metro area network architecture design, which thereby creates e-Highways, e-Roads and e-Streets.

### DETAILED DESCRIPTION

The following detailed description refers to the accompanying drawings. Wherever possible, the same reference numbers are used in the drawings and the following description to refer to the same or similar parts. While several embodiments and features of the invention are described herein, modifications, adaptations and other implementations are possible, without departing from the spirit and scope of the invention. Rather these embodiments are provided so that this disclosure will be complete and will fully convey the invention to those skilled in the art. For example, substitutions, additions or modifications may be made to the components illustrated in the drawings, and the methods described herein may be modified by substituting, reordering or adding steps to the disclosed methods. Accordingly, the following detailed description does not limit the invention. Instead, the proper scope of the invention is defined by the appended claims.

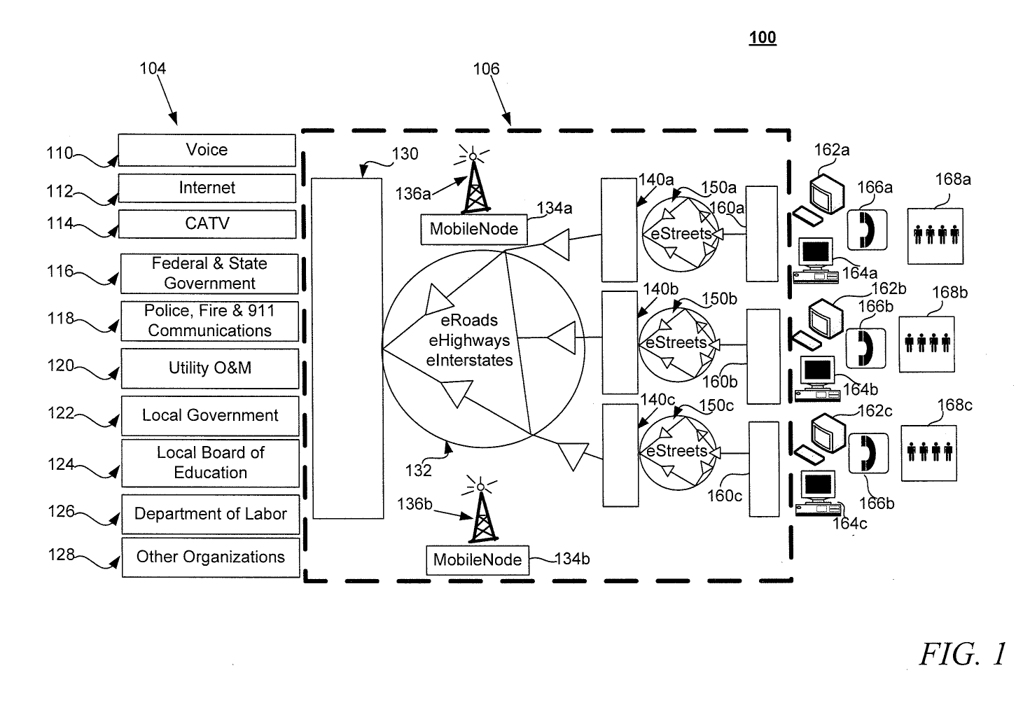

The present invention, a network broadband infrastructure that utilizes the CONVERGED BROADBAND INFRASTRUCTURE™ software module, shown in FIG. 1, enables the network broadband infrastructure illustrated to congregate the services of disparate telecommunications service and content providers onto a single broadband infrastructure, allowing an end user to have instant access to the content, voice, video and data services of a myriad of service and content providers that are connected to the network over a single connection. It is contemplated that the end users may be individuals, for profit and non-profit businesses and governments. Upon connection to the network broadband infrastructure 106, which is controlled by the CONVERGED BROADBAND INFRASTRUCTURE™ software module, end users connected to the network may be connected to one or all of a virtual community of service providers 104, such as service providers providing telecommunications voice service 110, internet service 112, cable television service 114, federal and state governmental entities 216, police/911/fire departments 218, utility O & M 220, local governments 222, local boards of education 224, department of labor 226, and any other agency 228 that has content or services that can be provided to end users over the network.

One aspect of the present invention is that the CONVERGED BROADBAND INFRASTRUCTURE™ software module utilized in the broadband network infrastructure 100 enables a plurality of voice service providers 110, a plurality of internet service providers 112, and a plurality of cable TV video service providers 114 to provide services to end users 162, 164, 166. The broadband network infrastructure system 100 is configured such that the video includes at least two RF with return cable providers, at least two Satellite Providers utilizing a single satellite headend, and at least one IPTV Provider.

The CONVERGED BROADBAND INFRASTRUCTURE™ software module is configured to enable the legacy systems such as the existing telecommunications voice infrastructure 110, existing internet infrastructure 112, and existing cable television infrastructure 114 to interface with the network broadband infrastructure 106 and thereby allow end users 162, 164, 166, through the broadband network infrastructure 106 to have access to any of the service and content providers within the virtual community of service providers 104. It is to be understood that only one service provider within the legacy systems 110, 112, 114 may be selected at any given time, allowing an end user 162, 164, 166 to select one voice provider 110, one internet provider 112 and one cable TV provider 114 from an associated port provided for voice, internet and cable TV service. It is also contemplated that if there is a need for legacy system infrastructure access other than the voice 110, internet 112, and cable TV 114 illustrated in FIG. 1, the CONVERGED BROADBAND INFRASTRUCTURE™ software module has the ability to accommodate additional legacy systems.

In the network broadband infrastructure 106 illustrated in FIG. 1, a TeleTOLL™ system 130 is provided. The TeleTOLL™ system 130 is the system that allows the systems of the virtual community of service providers 104 to connect in and interface with the network broadband infrastructure 106. The TeleTOLL™ system 130 has fiber connectivity 132 extending from one of its sides. Within the fiber connectivity 132 there are eRoads, eHighways and eInterstates that enable a unique methodology of routing traffic to the end users 162, 164 166. In the existing infrastructure environment, traffic is routed to end users as a one to one connection of how the connection between the central office and the end user can be traced all the way between the central office and the end user and all the way back from the end user to the central office. In the existing infrastructure environment if something breaks in the middle of the route between the central office and the end user, communication will be disabled. In the present invention, one break along a specific route does not result in communications being disabled because, similar to the brick and motor roads, highways and interstates, which allow for multiple routes from one location to the next, the present invention is a smart network that can determine when a break in an eRoad, eHighway or eInterstate occurs and reroute the communication to another efficient route without service being disabled. The software controlling TeleTOLL™ system 130 has been programmed with a plurality of alternative routes so that the system can immediately default to an alternative route upon the determination that there has been a break in an eRoad, eHighway or eInterstate. The system also reroutes traffic to different equipment within the network based on traffic load and functionality of the equipment which is being monitored by the software module.

O-DEMARC™ 160 is a system into which fiber is connected at a first side and on a second side, the user 168 connects a television 162, a computer 164 and a telephone 166. The O-DEMARC™ 160 unit is how the light signal coming in from the fiber is converted back to an electrical standard, allowing the end user 168 to use standard equipment. There is not a need for special equipment such as a VOIP phone.

The mobile node 134 and 136 enables a mobile communications platform to be integrated into the network broadband infrastructure 106. The mobile node 134 and 136 takes an RF signal within a wireless platform and converts it to a light signal so that it fits on the network broadband infrastructure 106. The network broadband infrastructure 106 includes mobile nodes 134 and 136 to enable mobile coverage in the same locations where fiber coverage is provided and replaces the cellular towers in areas in which network broadband infrastructure 106 is located. With the use of mobile nodes 136 and 134 the system allows users with cellular service to connect to the mobile nodes 134 and 136 instead of a cellular tower so that the cellular traffic is now being transmitted over the network broadband infrastructure 106 instead of connecting to the cell tower and the associated cellular network.

TeleNODE™ system 140 is a local version of the TeleTOLL™ system 130 including all of the internal routing capabilities, but lacking the functionality to connect to the systems of the virtual community of service providers 104. Similar to the TeleTOLL™ system 130, the TeleNODE™ system 140 is an intelligent routing system connected to fiber infrastructure 150 that includes eHighways, eRoads, and eStreets. It provides more redundancy by providing an intelligent routing system. Accordingly, if one of the connections with the fiber infrastructure 150 connected to a TeleNODE™ system 140 is broken there are other routes through which the communications between the TeleNODE™ system 140 and the O-DEMARC™ 160, within the end user premises, may be transmitted. Each TeleNODE™ system 140 has an associated mobile node which may be attached directly to the TeleNODE™ system or connected within a distance of six miles.

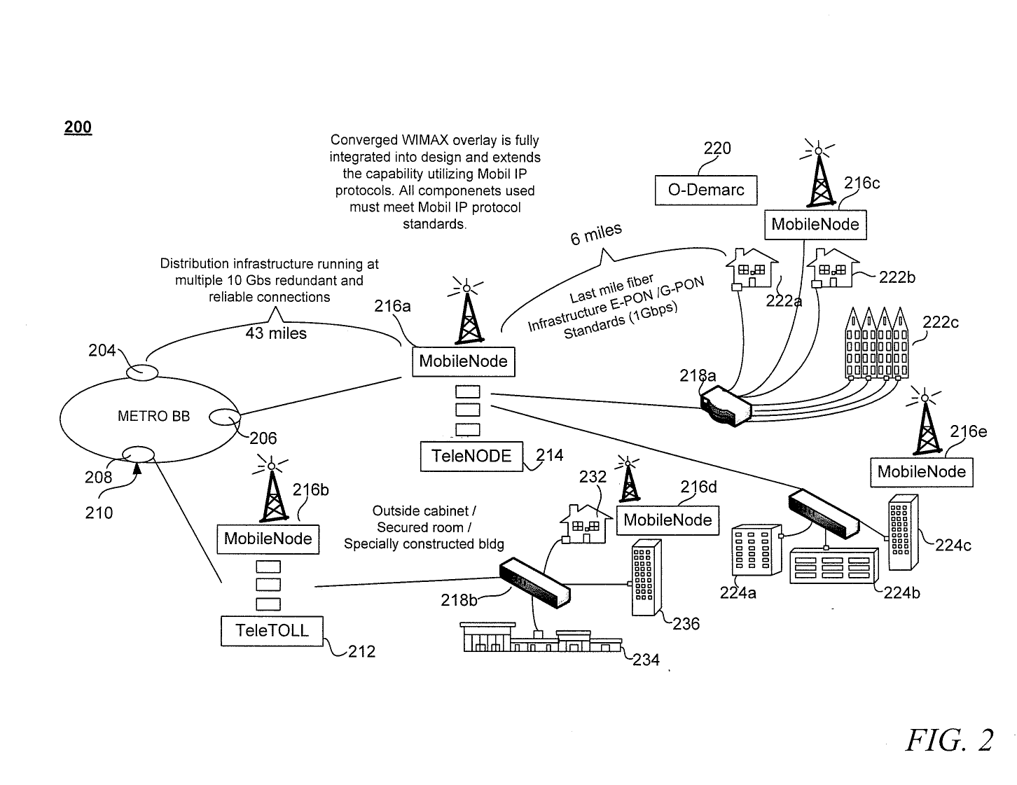

FIG. 2 is a more detailed illustration of the functional operation and connectivity of the network broadband infrastructure 200 controlled by the CONVERGED BROADBAND INFRASTRUCTURE™ software module. The network broadband infrastructure 200 illustrated in FIG. 2 enables the congregation of services offered by multiple telecommunications service and content providers thereon, allowing an end user to have instant access to the content, voice, video and data services of a myriad of service and content providers that are all connected to the network broadband infrastructure 200.

The metro area backbone 210 is comprised of a series of connected TeleTOLL™ and TeleNODE™ systems 204, 206, 208, which as illustrated are connected to other TeleTOLL™ 212 and TeleNODE™ systems 214 illustrated the breadth of the metro area backbone. Within the metro area backbone 210 comprising a series of connected TeleTOLL™ and TeleNODE™ systems 204, 206, 208, 212, 214 the maximum distance of a connection between any two TeleNODE™ systems, any two TeleTOLL™ systems or connected TeleTOLL™ and TeleNODE™ systems is forty three miles. The maximum distance of a connection between a mobile node 216 and an O-DEMARC™ device 220 is six miles. The concept of maximum distance between equipment highlights the concept that there is no power between the two pieces of equipment connected. Accordingly, there is an improvement of maintenance. As illustrated, the mobile node 216 is integrated into the broadband network infrastructure 200 and uses mobile IP protocols.

FIG. 2 also illustrates the breadth of the O-DEMARC™ device 220. As illustrated, the O-DEMARC™ device 220 may be configured for use in a home 222a, 222b, for use in an apartment building 222c, or many different industrial applications 224a, 224b, 224c. It is to be understood that even though the O-DEMARC™ device has many different applications, the functionality of the O-DEMARC™ device is the same but has multiple configurations depending on the type of end user that is attached to the network.

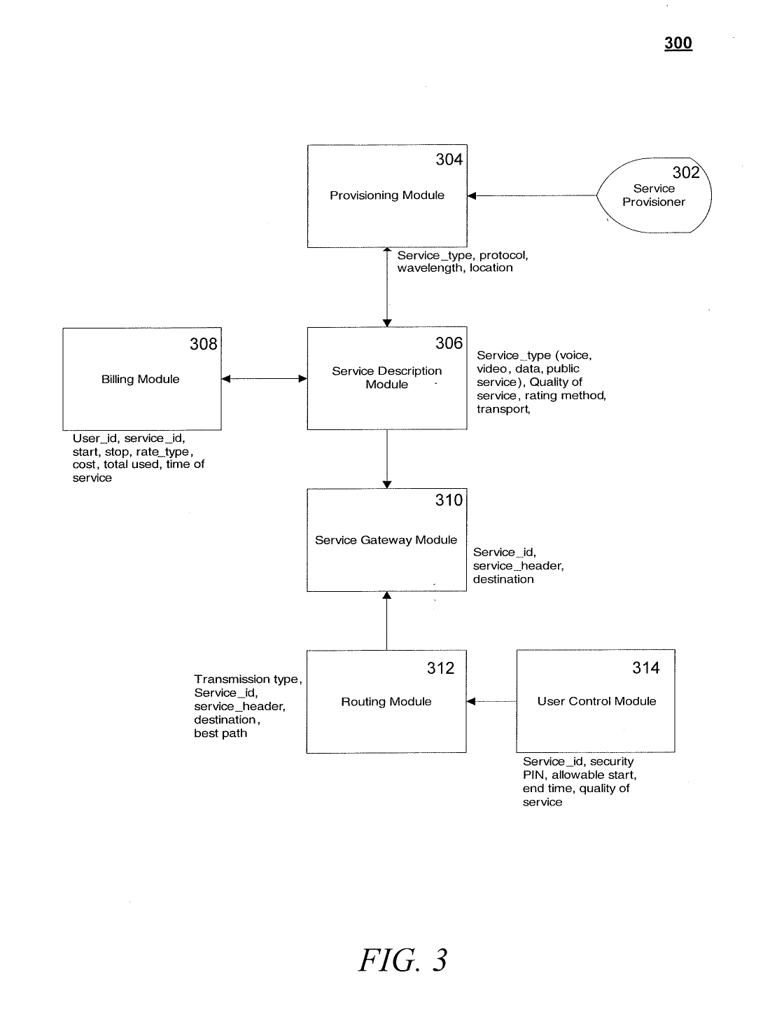

Referring to FIG. 3, a service provider 302 that has content is provided with a provisioning module 304 through use of the software module of the present invention. The provisioning module provides a graphical user interface (GUI) to describe the services being provided by the service provided to the end user. Further it allows for the assembling of these base components into larger more complex service offerings which may be exposed through the network broadband infrastructure 106 and consumed by end users. The Provisioning Service module utilizes the information in the Service Description Service. A specific application programming interface (API), provider ID, username and password is supplied to each service provider client. This API allows each service provider to provision services within the network broadband infrastructure 106 as they would on their own proprietary network infrastructure.

The software module also includes a services description module 306 that provides an interface to a service which describes the base service being offered for consumption. This information consists of a service type (voice, video, data, public service), Quality Of Service indicator, Rating Method, Protocol or Transport, Location of service (if offered via a URI), and transport wavelength. This information is easily updated, and searchable via a custom API. Each unique service is identified by a transmission type, service, identification. This module is used by the Service Gateway.

The software module also includes a services gateway module 310 that provides a service by which packets or RF signals sent across the CBI network infrastructure are inspected and routed to their destination. It accurately tracks packets from specific services providers to their proper destination. The service also encompasses wavelength modulation and tracking for high traffic networks. This allows for a data stream to be changed on the fly from one wavelength to another without losing security It uses the contents of the current Service Packet Header along with a companion service called the Routing Table Service to determine the destination of that particular service provider data packet. Gateway Services are deployed inside the CBI within the TeleNODE™ and O-DEMARC interfaces.

The software module also includes a routing module 312 that exposes an interface to the RF, TCP/IP or Wavelength Division Multiplexing Routing Table which, implements a Wavelength Division Multiplexing searchable interface into a routing table (via the Routing Table Manager) to determine the network destination of a particular packet of information. It uses a description of the service and the Service Packet Header given to it and returns a destination id. This ID consists of Transmission Type (RF, TCP/IP or wavelength), port, protocol conversion data and best path. The best path is determined by distance, congestion, available capacity, service level agreement, priority, and quality of service requirements. A table of e-Highways, e-Roads, and e-Streets with continued traffic congestion monitoring provides a unique multi-path routing service.

The software module also includes a user control module 314 that provides an interface to manage customer usage restrictions as defined by the end user. In the case of residential users it would constitute parental control information. For business customers, it may constitute time of day for services availability. The interface provides an API and GUI for the configuration of start and end time of service delivery, a listing of services subscribed to by the end user, security information to authorize usage of a particular service and other information.

The software module also includes a billing module 308 that provides an interface to a module which rates services sent across the CBI from the Service Provider to the Consumer of that service. It uses information in the Service Initiator, Service Header, and Service Terminator information sent across the CBI when a service is used to determine costs. It also tracks time of service usage, total amount of the service used, allows for the storage and change of rate information. The Service Initiator, Service Header, and Service Terminator are data components accompanying the data streams traveling across the CBI. The Service Initiator is sent before the actual service data is transported and contains the transmission type, service, id, time the service was started, as well as rating information and quality of service data. The Service Header contains transmission type, service id, service destination and quality of service information. The Service Terminator is the last data packet sent when a user stops utilizing a service. It contains the end time and last byte count of data used.

The above specification, examples and data provide a description of the manufacture and use of the invention. Since many embodiments of the invention can be made without departing from the spirit and scope of the invention, the invention resides in the claims hereinafter appended.

What is claimed is:

1. A method of converging the services and content provided by a plurality of providers onto a single broadband network comprising:
connecting a plurality of provider legacy systems to the single broadband network;
distributing services of the plurality of provider legacy systems to a plurality of end users over the single broadband network;
wherein the plurality of provider legacy systems include a plurality of provider legacy systems of the type offering at least one of the same type of services comprising voice, data and internet.
